(19) United States
(12) Patent Application Publication
(10) Pub. No.: US 2015/0170246 A1
(43) Pub. Date: Jun. 18, 2015

(54) Systems and Methods for Matching Consumers According to Size

(71) Applicants: Linda Shei Huang Zachariah, Mercer Island, WA (US); Jennifer L. Jolley, Seattle, WA (US)

(72) Inventors: Linda Shei Huang Zachariah, Mercer Island, WA (US); Jennifer L. Jolley, Seattle, WA (US)

(21) Appl. No.: 14/276,923

(22) Filed: May 13, 2014

Related U.S. Application Data
(60) Provisional application No. 61/916,590, filed on Dec. 16, 2013.

(51) Int. Cl. G06Q 30/06

(52) U.S. Cl. CPC G06Q 30/0625

(57) ABSTRACT

Embodiments of this application describe systems and methods for helping consumers find a “body double” by matching information associated with the consumers, such as reviews, size data, style preferences, etc.

### CROSS-REFERENCE TO RELATED APPLICATIONS

This application claims priority to provisional application no. 61/916,590, filed on Dec. 16, 2013, which is hereby incorporated by reference in its entirety.

### BACKGROUND

The proliferation of wireless devices such as smartphones and tablets has increased the amount of time that consumers spend shopping online. In addition, traditional brick and mortar retailers are expanding their online presence. For items such as clothing or shoes, however, the biggest challenge to shoppers and retailers is buying clothes that fit. A high percentage of clothing purchased online is returned, resulting in wasted time, hassle, and cost for the consumer and the retailer.

### BRIEF DESCRIPTION OF THE DRAWINGS

FIG. 1 is a block diagram of an example method in accordance with various embodiments of the present disclosure.

FIG. 2 is a block diagram of another example method in accordance with various embodiments of the present disclosure. FIG. 3 is a block diagram associated with the example methods of FIGS. 1 and 2.

FIG. 4 illustrates an example computing system/device suitable for use as a client device and/or server to practice various aspects of the invention in accordance with various embodiments of the present disclosure.

### DETAILED DESCRIPTION OF EMBODIMENTS

Embodiments of this application describe systems and methods for helping consumers or users find a ‘body double’ by matching information associated with the consumers, such as clothing reviews, size data, style preferences, etc. In embodiments, “article of clothing” may refer to any type of clothing worn on the body but may also refer to accessories and/or footwear, such as for example, but not limited to, sandals, shoes, or boots. In embodiments, a computing device may receive information related to a fit of a first article of clothing for a first user as well as information related to a fit of a second article of clothing for a second user. In embodiments, the information may include any information relevant to a purchase decision by a consumer, such as for example, but not limited to, fit, style, comfort, color, value, price, and quality of the article of clothing. In embodiments, the computing device may use the received information to determine a match between the first user and the second user based on similar experiences with respect to an article of clothing, in particular, the size of the particular item of clothing. In embodiments, the computing device may provide information related to the match to a remote client computing system (“client device”) which may assist a user in making future purchase decisions related to one or more articles of clothing. In embodiments, the consumer or user may login and browse information related to the match on the client device including, but not limited to, a laptop, desktop, and/or a wireless mobile device, e.g., smartphone, tablet, personal digital assistant (“PDA”), etc.

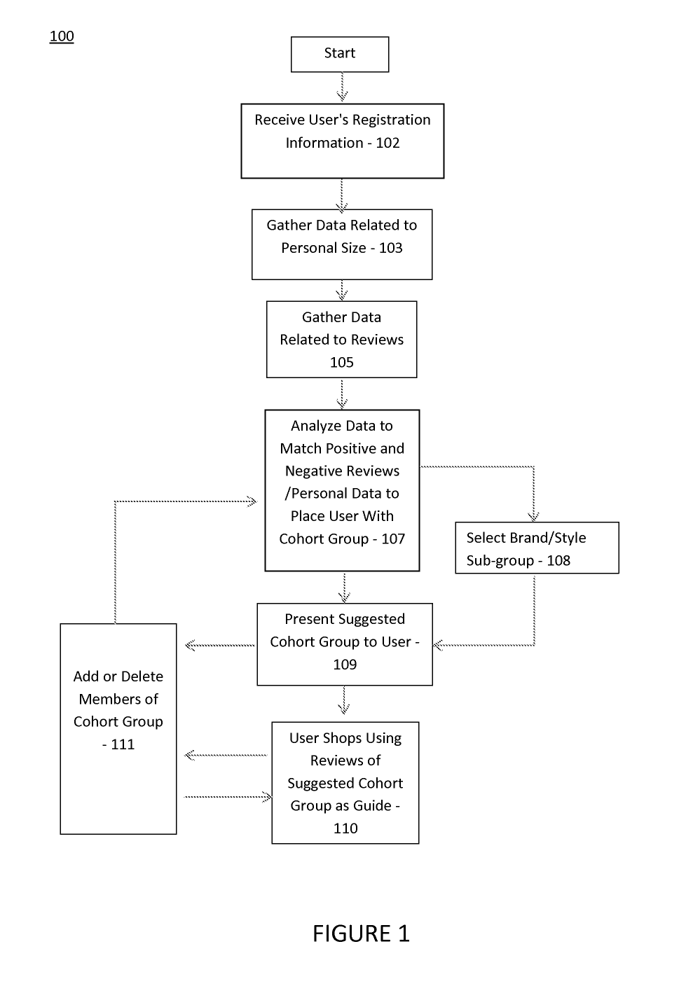

FIG. 1 illustrates an exemplary method 100 according to embodiments of the present invention. In embodiments, a consumer matching engine may provide a user with a cohort of “body doubles” in order to facilitate purchasing decisions. In embodiments, at a block 102, at an initial visit by a user to a website received from a computing device implementing embodiments of the invention, the user may register as a user of the website on a client device. In embodiments, this may include entering a name, address, or other identifying information. In embodiments, registration includes selecting a user name and password. At a next block 103, data may be gathered related to the user's size. Thus, in embodiments, information related to the user's size may be entered by the user. In some embodiments, information related to the user's style preferences may also be entered. In one embodiment, the information includes the size that the user typically wears for particular articles of clothing in one or more particular brands (e.g. size 4, in Banana Republic™). In embodiments, different sizes for different types of articles of clothing can be entered, e.g. tops, pants, skirts, shirts, shoes or boots, etc. Optionally, information from the user such as actual physical measurements associated with the user can be entered. The user may be prompted to enter optional data related to, for example, but not limited to, height, weight, bra size, measurements for hips, chest, waist, inseam, sleeve length, foot, and/or neck. In embodiments, since particular sizes in particular brands may vary for different articles of clothing, measurements may be extrapolated from the data. In embodiments, where actual measurements are not entered or only some measurements, the computing device may generate/produce general measurement ranges associated with the user from the entered data.

In embodiments, at a next block 105, information or data related to reviews of clothing written or made by the user may be received. This may include for example, an actual review entered directly into the present website corresponding to an article of clothing, e.g., jeans or a shoe/boot purchased or tried on, or text of (or a link to) a review that was previously completed on a retailer's online website for the article of clothing. In some embodiments, the review does not need to have text, it can merely have a rating or answers to one or more questions, e.g., whether the item was a “keeper” as well as other questions/ratings related to fit, comfort, value, style, etc. In embodiments, the user may be prompted to enter size information manually for the article of clothing that was reviewed. In embodiments, the user can scan in or enter numbers associated with a Quick Response Code (“QR code”), Universal Product Code (“UPC code”), or other identifying code or number corresponding to the article of clothing or item. In embodiments, the code may be included on a smart tag or other tag associated with the item and provide basic identification of the article of clothing. In embodiments, the code may also provide a size of the article of clothing. Note that accessories such as, but not limited to, jewelry, sunglasses, belts, scarves, hats, gloves, watches, and hair accessories etc., may also be included as an item or article of clothing in the context of this disclosure.

At a next block 107, the data gathered at block 103 and/or 105 may be analyzed to place the user/consumer into a cohort group. Thus in embodiments, positive and/or negative reviews as well as personal size and style preference data may be used to match users. In embodiments, the cohort group includes users whose reviews for particular articles of clothing (in embodiments, having same or similar sizes) are similarly positive or negative and are thus a ‘body double’ for each other. In various embodiments, the cohort group may include just a few people or up to as many people that have similar data that correlate to the user and would provide potentially useful purchase/review information. In embodiments, different extrapolation methods depending upon the data available as gathered in blocks 103 and/or 105 may be used to determine the cohort group. For example, users that do not have reviews to enter can simply enter what size they wear in a preferred brand (as discussed above in connection with block 103) to be matched with others who accordingly appear to have similar body types, size, and/or style preferences.

In embodiments, method 100 may branch to a right block 108 where the user may select a brand or style sub-group in order to further narrow/personalize his or her cohort group. For example, some consumers may typically shop at 1-3 retailers or only prefer particular brands and may choose to narrow their cohort group to members who shop at these certain retailers and/or purchase these particular brands. Thus, in embodiments, the user may choose to only see purchases from their cohort group members that fall under one or more types of articles of clothing or particular brands or classes of brands (e.g., designer, mid-range price or athletic wear, professional wear, etc.). In other embodiments, software associated with the computing device may automatically select a brand/store/style subgroup according to data submitted by the user.

In embodiments (not shown), block 108 can occur prior to or within block 107. In embodiments, selecting a brand/style sub-group may be a part of matching a user to find a cohort group. In other embodiments, block 108 may be skipped and the user's cohort group may not be narrowed to particular brands or styles.

In embodiments, at a next block 109, a suggested cohort group may be presented to the user. The user name or screen names as well as access to recent reviews or purchases by members of the cohort group may be provided. In some embodiments, small icons representing recently reviewed or purchased articles may be displayed next to the user name of the individual member(s) of cohort group who reviewed/purchased the items. For example, small icons of, e,g., a V-neck sweater, pants, dresses, etc., including colors and styles of items reviewed/purchased during a particular recent period of time may be displayed. In embodiments, once the user clicks on the icon, more information about the purchase may be displayed. Note that in embodiments, users may include as much or as little information in their reviews. In embodiments, users may upload photos/video of the articles of clothing or of themselves wearing the article of clothing associated with the review. Note that although the focus of the method has been on online purchases, the user may also include information and photos about an article of clothing not available online, specifying a brand and where the article of clothing may be purchased.

In embodiments, after a block 109, the method may proceed to either a next block 110 or branch to a left block 111. In embodiments, at block 111, after reviewing the presented cohort group, the user may add or delete members from his or her cohort group. In embodiments, the user may edit the cohort group after browsing different members' profiles. Note that in embodiments, profiles of users/members may display as little or as much as the user/member desires. For example, some users may only display recent purchases while others may include actual measurements, weight, height, style preferences, geographic location, age range, etc., to determine whether users are a good ‘body double’ or ‘style double’ for each other.

In embodiments, after the user edits his or her cohort group, or if the user did not choose to edit his or her cohort group, the method flows to a next block 110, where the user may shop using one or more of the cohort group members' purchases and/or reviews as a guide. In embodiments, photos and other information of particular articles of clothing may be presented to the user either on the website or via links to a retailer's website where the articles of clothing may be browsed and purchased. In other embodiments, articles of clothing may be purchased directly on the website, rather than via the retailer's website. In embodiments, some articles of clothing or items may no longer be available. In embodiments, a status of the article of clothing may be indicated in the review, photo, or icon, associated with the article of clothing. In embodiments, the status may include whether the article of clothing is still available but may also include a price drop/sale of the article of clothing, etc. In embodiments, even though the particular article of clothing may no longer be available for purchase, the identifying information and review may remain on the website or dashboard for reference. Other cohort group members or potential cohort group members may browse such purchases which may help them to determine whether the user is a good ‘body double’ size-wise and/or style match.

In embodiments, the method 100 may move dynamically to and from block 111 as the user edits his or her cohort group. In the embodiment, according to the user's or cohort group members' latest reviews, members may be added or deleted from the user's cohort group. In embodiments, the cohort group members may be automatically added or suggestions made to edit the cohort group based on updated information related to fit and style of the user and/or member of the cohort group.

Note that the order or presentation of blocks in FIG. 1, 2, or 3 are only exemplary and deletions, additions, reordering of the blocks, may occur within the spirit of embodiments of the invention.

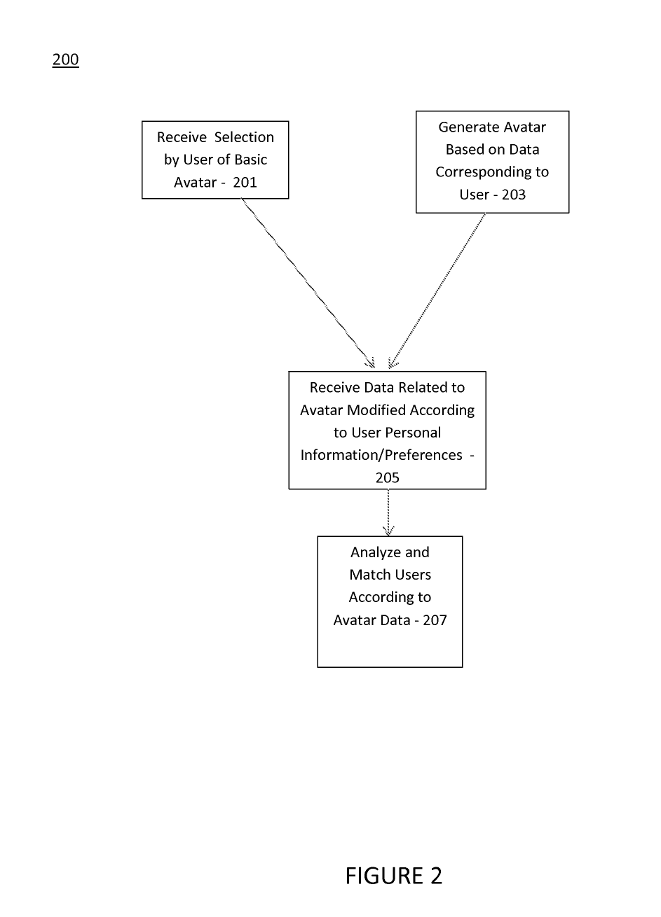

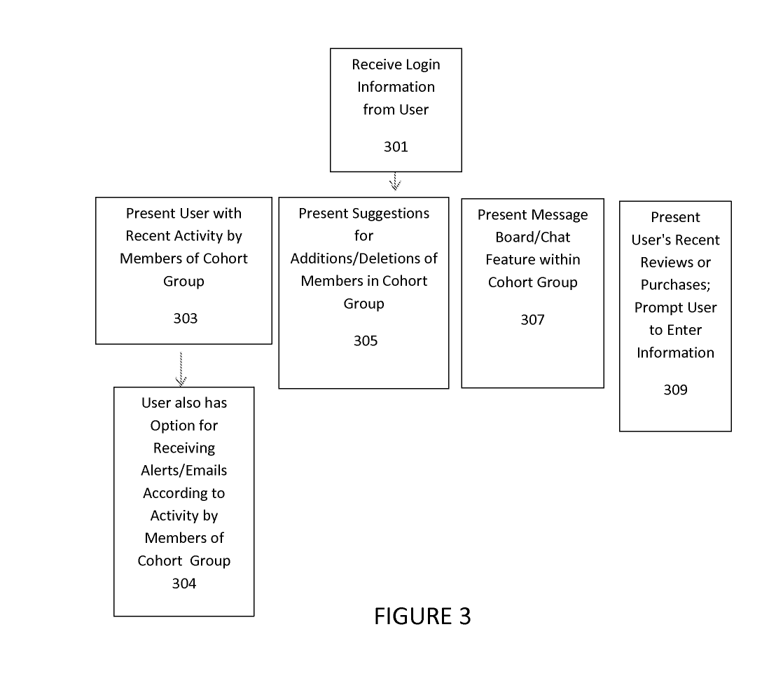

Next, FIG. 2 illustrates an embodiment associated with FIG. 1. In embodiments, an Avatar representing the user may be created or selected which reflects a preferred size, body type, etc., and in embodiments, style, of the user. In embodiments, the user may select a basic Avatar at a block 201, or in embodiments, an Avatar can be automatically generated based on data corresponding to the user at a block 203. Thus, if the user does not select his or her own basic or ‘starting Avatar’, in embodiments, the computing device may analyze data received in accordance with blocks 103 and 105 of FIG. 1 to present an Avatar to the user. In embodiments, a basic Avatar may include building blocks of an avatar with basic characteristics associated with the user. For example, the Avatar may be petite, skinny, tall, curvy, full-figured, broad-shouldered, etc.; the Avatar may reflect a user's hairstyle, color or skin tone as so desired. Thus, in the embodiment, data related to the user's selection of a basic avatar may be received at block 201. From block 201 or 203, at a next block 205, the user may modify/further modify the Avatar according to his or her personal information/preferences. For example, the user may either enter information that will modify the appearance and associated data of the Avatar or may dynamically change the Avatar's appearance. For example, the user may click and drag to increase or decrease a waist size, arm length, bust size, etc. In embodiments, as the user hovers a mouse or curser over different parts of the Avatar (which can in embodiments, be enlarged to screen size for editing or other purposes), a measurement or size associated with that portion of the body may appear, e.g. “28 inch waist” or “size 6 pants” etc., depending upon the information that the computing device may have in a database. In embodiments, for example, if the user decides to decrease or increase the size of his or her waist, as he/she drags the waist size inward or outward, sizes associated with the changing dimension may appear on the screen so that he/she may stop when the appropriate size is reached. In embodiments, the size may appear as “size 6, XX brand.” In embodiments, these sizes may also be determined from information gathered from reviews.

In embodiments, after block 205, the method flows to a next block 207 where data/features associated with the Avatars may be analyzed and matched in conjunction with review information already gathered to assist in creating a cohort group for the user. In embodiments, block 207 may be similar to or correspond to block 107 of FIG. 1 where the inputted/extrapolated data related to a size and style of the user is analyzed to assist in placing the user with a cohort group. In embodiments, the actions associated with blocks 201, 203 and 205 can be included in or used in conjunction with the method described at blocks 103 and 105 in FIG. 1, where data related to the size/style/body type of the user is gathered.

FIG. 3 illustrates an embodiment associated with FIGS. 1 and/or 2. In embodiments, at a block 301, login information may be received from the user. In embodiments, once a password is received, a dashboard or initial screen may be presented to the user. In embodiments, one or more of blocks 303-309 may be included in the dashboard or initial screen. For example, at a block 303, information indicating recent activity by members of the user's cohort group may be presented. In embodiments, recent activity may include recent purchases, reviews, uploads, etc. by particular cohort group members. In embodiments, at a block 304, the user may be presented with an option to receive alerts/emails/texts notifying him/her of cohort group member activities. At a block 305, suggestions for additions/deletions of members in the user's cohort group may presented. At a block 307, a message board/chat feature for the cohort group or other group as so selected or suggested may be available to the user. In embodiments, the user may request opinions or suggestions from their cohort group, or outside of their cohort group if so desired, regarding articles of clothing. For example, the user may request an opinion regarding a particular item of clothing they are considering purchasing. Or, in another example, a user may simply put out a request for suggestions for purchasing, e.g., a pair of black skinny jeans. In embodiments, at block 309, the user's “closet” can be presented, presenting the user's recent reviews or purchases. In embodiments, a user profile may also appear and can be edited by the user. In embodiments, the user may be prompted to enter additional information about his or her recent activity.

Note that in embodiments, the user may login to the website and enter reviews, purchase information, etc., using a mobile application (“app”) associated with the website on e.g., a smartphone or tablet. In some embodiments, if a user would like to enter a review about an article of clothing, identifying information regarding the article of clothing may be received via a QR scan, UPC, or other barcode or electronic entry. In embodiments, the app may prompt the user for as little or as much review information that the user would like to enter. In embodiments, the user may rate the article using a rating system, e.g., 5-star system or a positive or negative answer to the question of whether they recommend this article of clothing or product.

Note that in embodiments, the website may be associated with providing a private label product and/or service to retailers. Thus, in embodiments, certain portions of the registration and data gathering as described above in relation to e.g., blocks 102-105 of FIG. 1, may be simplified or omitted in the case that the user is a customer of a retailer and his or her data is already accessible to one or more computing devices implementing the embodiment. Note that in some embodiments and as would apply to block 107, users who have purchased an identical item in an identical size from a same retailer with a positive review may be instantly placed into the same cohort group. In embodiments, a link presented on an online retailer's website may take the user to the present website in order to have the review and article of clothing included in the user's profile and/or recent activity, etc.

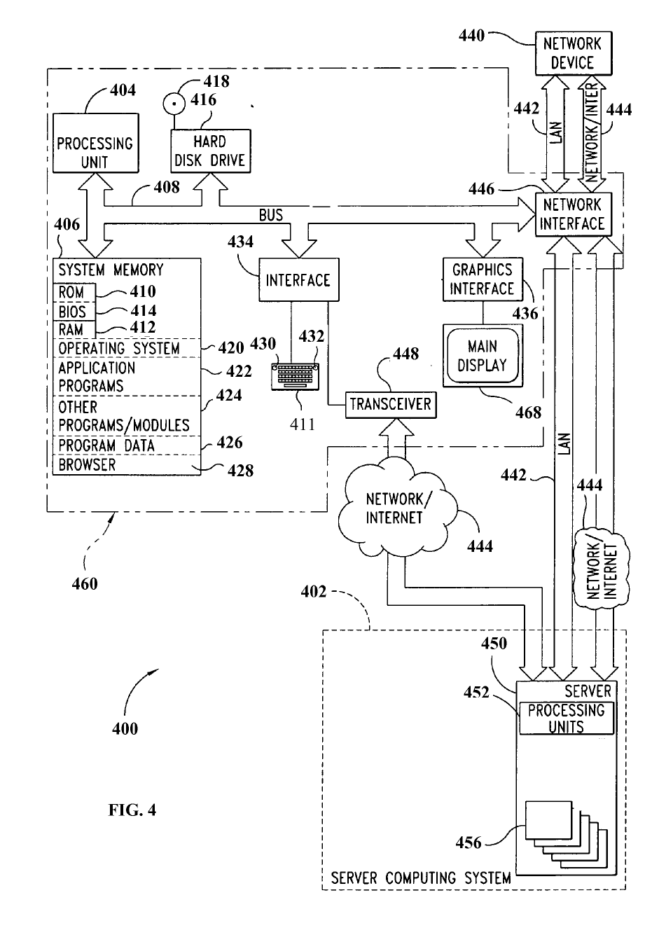

FIG. 4 and the accompanying discussion provide a description of a suitable computing environment in which embodiments as described above with respect to FIGS. 1-3 can be implemented. Embodiments can be implemented by hardware and computer-executable instructions, such as program application modules, objects, or macros that are capable of being executed by a computer. FIG. 4 shows a computing system 400 and a network environment in which the computing system 400 may be used. The computing system 400 includes a computing device 460 and a server computing system 402. In various embodiments, computing device 460 may be a desktop computer, portable computer such as for example a tablet or laptop, or other wired or wireless device. The server computing system 402 may be located at one or more network locations, to store and serve information for the computing device 460 and other clients. Note that in embodiments, the below described components of and associated with computing device 460 also apply to server computing system 402.

The computing device 460 includes a processing unit 404, a system memory 406, and a system bus 408 that couples various system components including the system memory 406 to the processing unit 404. The processing unit 404 may be any logic processing unit, such as one or more central processing units (CPUs), digital signal processors (DSPs), application-specific integrated circuits (ASICs), etc. The system bus 408 can employ any suitable bus structure or architecture, including a memory bus with memory controller, a peripheral bus, and a local bus. The system memory 406 includes read-only memory (ROM) 410 and random access memory (RAM) 412. A basic input/output system (BIOS) 414, which can form part of the ROM 410, contains routines that help transfer information between elements within the computing device, such as during start-up.

Computing device 460 may include a hard disk drive 416 for reading from and writing to a hard disk 418. The hard disk drive 416 communicates with the processing unit 404 via the system bus 408. The hard disk drive 416 may include interfaces or controllers (not shown) coupled between such drive(s) and the bus 408. The hard disk drive 416 and its associated hard disk 418 provide nonvolatile storage of computer readable instructions, data structures, program modules and other data. Among these computer readable instructions, which as noted above, may be located in server computing system 402 as well, data structures, program modules and so forth are instructions, data structures and modules configured to implement one or more aspects of the earlier described applications described in connection with FIGS. 1, 2, and 3.

Although the depicted computing device employs the hard disk drive 416 and the hard disk 418, other types of drives and computer-readable media that are capable of storing data accessible by a computer may be employed, such as compact disks (CDs), magnetic cassettes, flash memory cards, digital video disks (DVDs), Bernoulli cartridges, RAMs, ROMs, smart cards, etc. In one embodiment, the hard disk drive 416 and/or other drives are not integrated within a housing of the computing device 460 itself, but instead are external devices that are accessible via hardwire or wireless communication interfaces.

Program modules can be stored in the system memory 406, such as an operating system 420, one or more application programs 422, other programs or modules 424, and program data 426. An example operating system 420 that may be used is Windows Server 2012™ commercially available from Microsoft Corporation of Redmond, Wash. The program data 426 can be stored as a data structure, file, or other data format in a cache, database, or other storage unit integrated in or separate from the system memory 406.

The computing device 460 may also include a web browser 428 for permitting the computing device 460 to access and exchange data with sources such as Internet web sites, corporate intranets, or other networks as described below, as well as other server applications on server computers. For example, in embodiments, the information related to a user's cohort group may be provided to the user via a website or web page sent to the client device or computing device 460 which displays the website using a browser. While shown in FIG. 4 as being stored in the system memory 406, the operating system 420, application programs 422, other programs/modules 424, program data 426, and browser 428 can be stored in the hard disk 418 of the hard disk drive 416 and/or other computer-readable media.

A user can enter commands and information into the computing device 460 through input devices (such as the keyboard 411) and a pointing device such as a mouse 430. Alternatively or additionally, the mouse 430 can be embodied as a touch pad as compared to physical buttons. Another input device may take the form of one or more buttons 432 on the side of the keyboard 110, with the button(s) 432 usable for scrolling and clicking via turning and pressing of the button(s) 432. Other possible input devices can include a microphone, joystick, game pad, scanner, etc. (not shown). These and other input devices are connected to the processing unit 404 through an interface 434 such as a serial port interface that couples to the bus 408, although other interfaces such as a parallel port, a game port or a wireless interface or a universal serial bus (USB) can be used. The interface 434 can be any suitable communication interface to the bus 408 and need not necessarily be a port per se.

The display screen 468 operates as the main display and is coupled to the bus 408 via a graphics interface 436, such as a video adapter or other graphics component that will allow video and other graphics to be rendered on the display screen 468. The computing device 460 can operate in a networked environment using logical connections to one or more networked computers and/or devices, such as the server computing system 402 and a network device 440, such as a printer or network storage unit. The computing device 460 is logically connected to one or more networked computing systems or devices under any suitable method of permitting computers to communicate, such as through a wireless local area network (LAN) 442, a wireless wide area network (WWAN), or any other network 444, including wired and wireless networks that use or can communicate with the Internet (e.g., World Wide Web). Other embodiments include other types of communication networks including telecommunications networks, cellular networks, paging networks, and other mobile networks. Examples of wireless systems and protocols with which the computing device 460 can communicate, include but are not limited to, Wi-Fi, Bluetooth, 802.11, and others.

When used in a LAN networking environment, the computing device 460 can be connected to the LAN 442 through an adapter or network interface 446 (communicatively linked to the bus 408). When used in a WWAN or other network 444, the computing device 460 may include a modem, transceiver 448 or other device, such as the network interface 446, for establishing communications over this networking environment. The transceiver 448 as shown in FIG. 4 is communicatively linked between the interface 434 and the network 444, for communicating between the computing device 460 and the server computing system 402, for instance.

In one embodiment, the computing device 460 is communicatively linked to the server computing system 402 through the LAN 442 and/or the network 444 with transmission control protocol/Internet protocol (TCP/IP) middle layer network protocols or other network protocol layers, such as User Datagram Protocol (UDP). The network connections shown in FIG. 4 are only some examples of establishing communication links between computers, and other links can be used, including both hardwire and wireless links.

The server computing system 402 (which can comprise a hardware computing system, software computing system, or combination of both) includes one or more servers 450. A server can provide services associated with a consumer matching engine such as that for analyzing size and apparel review services to match users as described in connection with FIGS. 1-3 and may comprise hardware, software, firmware, or combinations thereof that provide such files and services, including for example, a single hardware server that runs multiple server software. The server 450 can include one or more processing units 452, which can comprise CPUs, controllers, processors, and the like, that work in conjunction with server applications for the routing of information between the computing device 460 (and other clients) and the server computing system 402.

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein.

We claim:

1. A method, comprising:
receiving, by a computing device, information related to a fit of a first article of clothing of a first user;
receiving, by the computing device, information related to a fit of a second article of clothing of a second user; and
using, by the computing device, the information related to the fit of the first article of clothing and the fit of the second article of clothing, to determine a match between the first user and the second user.

2. The method of claim 1, further comprising, providing by the computing device to the first user, information related to the fit of the second article of clothing, to assist the first user in making a purchase decision.

3. The method of claim 1, further comprising, receiving by the computing device, information related to a fit of a third article of clothing by a third user, and using the information related to the fit of the third article of clothing to match the third user with the first and the second user.

4. The method of claim 1, wherein the information related to the fit of the first article of clothing and the information related to the fit of the second article of clothing includes information related to a respective size and brand worn by the first user of the first article of clothing and a size and brand worn by the second user of the second article of clothing.

5. The method of claim 1, wherein the information related to the fit of the first article of clothing and the information related to the fit of the second article of clothing includes a respective first clothing review written by the first user and a second clothing review written by the second user.

6. The method of claim 1, wherein the information related to the fit of the first article of clothing and the fit of the second article of clothing includes information related to a style, quality, comfort, price, and color of the respective article of clothing.

7. The method of claim 1, wherein the first article of clothing and the second article of clothing includes one of clothing, shoes, boots, sandals, and accessories.

8. A computing device configured to:
receive information related to a fit of a first article of clothing and a first user;
receive information related to a fit of a second article of clothing and a second user; and
use the information related to the fit of the first article of clothing and the fit of the second article of clothing, to determine a match between the first user and the second user.

9. The computing device of claim 8, wherein the information related to the fit of the first article of clothing and the fit of the second article of clothing includes information related to a size and brand of the respective first article of clothing and the second article of clothing.

10. The computing device of claim 8, wherein the computing device is further configured to provide information to the first user related to a future article of clothing purchased by the second user in order to assist the first user in making a purchase decision.

11. The computing device of claim 8, wherein the information related to the fit of the first article of clothing and the information related to the fit of the second article of clothing includes a respective first clothing review written by the first user and a second clothing review written by the second user.

12. The computing device of claim 8, wherein the computing device is configured to receive information provided by the first user and the second user related to a body size and body type of the respective first user and the second user.

13. The computing device of claim 8, wherein the information related to the fit of the first article of clothing and the fit of the second article of clothing includes information related to a style, quality, comfort, price, and color of the first article of clothing or the second article of clothing.

14. The computing device of claim 8 wherein the computing device is further configured to receive information related to the first article of clothing or the second article of clothing via a code associated with the first article of clothing or the second article of clothing.

15. A method, comprising:
receiving, by a computing device, information related to how a first article of clothing fits a first user and information related to how a second article of clothing fits a second user; and
using, by the computing device, the information related to how the first article of clothing fits the first user and how the second article of clothing fits the second user to determine whether the first user and the second user have a similar body size and body type.

16. The method of claim 15 further comprising receiving, by the computing device, information submitted by the first user providing a body size and body type of the first user.

17. The method of claim 16 further comprising using, by the computing device, the information related to how the first article of clothing fits the first user and how the second article of clothing fits the second user in conjunction with the information submitted by the first user to determine whether the first user and the second user have a similar body size and body type.
